(19) United States
(12) Patent Application Publication
(10) Pub. No.: US 2018/0346751 A1
(43) Pub. Date: Dec. 6, 2018

(54) HIGHLY FUNCTIONAL AF HARD COATING FILM

(71) Applicant: KOREA INNOTEC CO., LTD., Changwon (KR)

(72) Inventors: Hyun Don KIM, Anyang (KR); Kwang Muk PARK, Changwon (KR)

(21) Appl. No.: 15/780,616

(22) PCT Filed: Feb. 14, 2017
(86) PCT No.: PCT/KR2017/001605

§ 371 Date: May 31, 2018

(30) Foreign Application Priority Data
Mar. 14, 2016 (KR) 10-2016-0030338

(51) Int. Cl. C09D 127/12; C09D 7/63; C09D 5/16; B32B 27/30; B32B 7/02; B32B 17/06

(52) U.S. Cl. CPC C09D 127/12; C09D 7/63; C09D 5/1662; B32B 2457/20; B32B 7/02; B32B 17/064; B32B 27/304

(57) ABSTRACT

Disclosed is a highly functional AF hard coating film, which includes a transparent substrate layer, a hard coating layer formed on the transparent substrate layer and composed of a compound including a structure having reactivity with an alkoxysilane group, and an AF coating layer formed on the hard coating layer and composed of a perfluoro compound containing an alkoxysilane group, and can exhibit high functionality, such as high hardness, high scratch resistance, anti-glare and anti-fouling, and is thus suitable for replacing an existing display tempered glass cover window or serving as a film for protecting tempered glass.

### TECHNICAL FIELD

The present invention relates to an AF hard coating film, which has high functionality, such as high hardness, high scratch resistance, anti-glare and anti-fouling, a protects the surface of a display.

### BACKGROUND ART

In order to protect displays such as those of mobile devices, touch panels, car navigation systems and the like, or to achieve a good outer appearance thereof, a cover window, which is thin and planar, is disposed on the entire front surface of a display so as to be larger than an image display area.

As a cover window, tempered glass is used, and glass is superior in heat resistance, light transmittance and mechanical strength, but is heavy and fragile and is difficult to apply to a flexible display. In order to replace glass, a transparent plastic film having superior thermal and optical properties is being considered in related industries.

Compared to a glass substrate, a plastic film has very high mechanical flexibility but exhibits poor strength and surface hardness, and may thus include a hard coating layer. The case where a functional thin-film layer such as an anti-fouling coating layer or the like is stacked on the hard coating layer is problematic in terms of easy peeling due to external wear. Thorough research into increasing the strength of a plastic film that is used, such as devising a polyimide film impregnated with glass fabric as disclosed in Korean Patent No. 10-1482707 (Jan. 08, 2015), etc., is ongoing.

### DISCLOSURE

### Technical Problem

Accordingly, the present invention has been made keeping in mind the problems in the related art, and the present invention is intended to provide an AF hard coating film, which has high functionality, such as high hardness, high scratch resistance, anti-glare and anti-fouling, and is thus suitable for replacing an existing display tempered glass cover window or serving as a film for protecting tempered glass.

The aspects of the present invention are not limited to the foregoing, and the other aspects which are not mentioned herein will be able to be clearly understood to those skilled in the art from the following description.

### Technical Solution

The present invention provides a highly functional

AF hard coating film, comprising a transparent substrate layer; a hard coating layer formed on the transparent substrate layer and composed of a compound including a structure having reactivity with an alkoxysilane group; and an AF coating layer formed on the hard coating layer and composed of a perfluoro compound containing an alkoxysilane group.

Also, in the highly functional AF hard coating film, the AF coating layer is a coating layer formed of a compound represented by Chemical Formula 1 below.

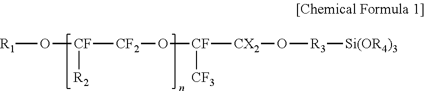

Also, in the highly functional AF hard coating film, the hard coating layer is a high-strength coating layer formed of an acrylic photocurable resin including an organosilicon compound having a cubic structure [RSiO_{3/2}]ₙ, with a thickness of 5 to 50 μm, and preferably 10 to 30 μm.

In Chemical Formula 1, R₁ is a C₁-C₇ alkyl group substituted with F, R₂ is F or CF₃, R3 is a C₁-C₁₀ alkyl group or alkoxy group unsubstituted or substituted with F, R₄ is a C₁-C₃ alkyl group, and X is H or F.

Also, in the highly functional AF hard coating film, the hard coating layer is a high-strength coating layer formed of an acrylic photocurable resin including nano silica, with a thickness of 5 to 50 μm.

Also, in the highly functional AF hard coating film, the hard coating layer is an anti-glare coating layer formed of an acrylic photocurable resin including at least one of amorphous silica particles and bead particles, with a thickness of 5 to 50 μm.

Also, in the highly functional AF hard coating film, the transparent substrate layer has a thickness of 20 to 3000 μm, and the AF coating layer has a thickness of 5 to 50 μm.

Also, the highly functional AF hard coating film further includes a silicone adhesive layer, the transparent substrate layer being formed on the silicone adhesive layer.

### Advantageous Effects

According to the present invention, a highly functional AF hard coating film includes a hard coating layer, the composition and thickness of which vary, and is thus suitably applied so as to realize requirements such as high film hardness or anti-glare performance.

The highly functional AF hard coating film can exhibit superior scratch resistance, wear resistance, anti-fouling and anti-fingerprinting while significantly reducing the peeling of an AF coating layer formed on a hard coating layer by virtue of the composition of the hard coating layer and the composition of the AF coating layer.

Also, the highly functional AF hard coating film can be applied to displays such as those of mobile devices, touch panels, car navigation systems and the like, and can thus be used to replace a cover window or to protect tempered glass of a cover window.

### DESCRIPTION OF DRAWINGS

FIG. 1 shows the construction of a highly functional AF hard coating film according to an embodiment of the present invention;

FIG. 2 shows the construction of a highly functional AF hard coating film according to an embodiment of the present invention;

FIG. 3 shows the construction of a highly functional AF hard coating film according to an embodiment of the present invention;

FIGS. 4 and 5 show the surface images after measurement of scratch resistance of the highly functional AF hard coating film manufactured in Example of the present invention and the hard coating film manufactured in Comparative Example; and

FIG. 6 shows the images after measurement of the water contact angle of the highly functional AF hard coating films manufactured in Examples of the present invention.

### MODE FOR INVENTION

In the following description of the present invention, the terms used herein are merely intended to describe specific embodiments and are not to be construed as limiting the scope of the present invention, which is defined by the appended claims. Unless otherwise defined, all technical or scientific terms used herein have the same meanings as those typically understood by persons having ordinary knowledge in the art to which the present invention belongs.

Unless otherwise stated, the terms “comprise”, “comprises” and “comprising” are used to designate the presence of an object, a step or groups of objects and steps described in the specification and claims, and should be understood as not excluding the presence or additional probability of any other objects, steps or groups of objects or steps.

Unless otherwise noted, various embodiments of the present invention may be combined with any other embodiments. In particular, any feature which is mentioned preferably or favorably may be combined with any other features which may be mentioned preferably or favorably. Hereinafter, a description will be given of embodiments of the present invention and effects thereof with reference to the appended drawings.

According to an embodiment of the present invention, a highly functional AF hard coating film 100 includes a transparent substrate layer 10, a hard coating layer 20 formed on the transparent substrate layer, and an AF coating layer 30 formed on the hard coating layer. FIG. 1 shows the construction of the highly functional AF hard coating film according to an embodiment of the present invention.

In the highly functional AF hard coating film, the hard coating layer 20 functions to exhibit high film strength or anti-glare performance, and the AF coating layer 30 may exhibit superior adhesion to the hard coating layer 20, as well as anti-fouling performance.

More specifically, the hard coating layer 20 formed on the transparent substrate layer 10 is a high-strength coating layer formed of a compound including a structure having reactivity with an alkoxysilane group, and the AF coating layer 30 formed on the hard coating layer 20 is an anti-fouling coating layer formed of a perfluoro compound containing an alkoxysilane group.

In an embodiment of the present invention, the transparent substrate layer 10 functions as a substrate for a film, and is a layer formed of at least one selected from the group consisting of polyethylene terephthalate (PET), polymethyl methacrylate (PMMA), polycarbonate (PC), polystyrene (PS), polyimide (PI), polyphenylene sulfide (PPS), polyethylene naphthalate (PEN), polyether sulfone (PES) and allyl resin.

Preferably provided is a layer formed of at least one selected from the group consisting of polyethylene terephthalate (PET), polymethyl methacrylate (PMMA), and polycarbonate (PC).

Also, the transparent substrate layer 10 may have a thickness ranging from 20 to 3000 μm. If the thickness thereof is less than 20 μm, the substrate layer is too thin, undesirably making it impossible to control the occurrence of curling upon curing shrinkage after coating with the upper hard coating layer. On the other hand, if the thickness thereof exceeds 3000 μm, the substrate layer is too thick, undesirably lowering light transmittance, decreasing the touch speed upon use as a cover for a touch screen panel (TSP), and increasing the total thickness upon mounting to a TSP.

In an embodiment of the present invention, the hard coating layer 20 is formed on the transparent substrate layer to thus enhance the strength of the film, and is a high-strength coating layer formed of a compound including a structure having high reactivity with an alkoxysilane group. It may be formed of various kinds of materials depending on the strength and properties required of a film.

When the highly functional AF hard coating film 100 is required to have strength corresponding to ultrahigh hardness equivalent to a pencil hardness of 8 H or more, the hard coating layer 20 is formed of an acrylic photocurable resin including an organosilicon compound having a cubic structure [R₅SiO3/2]ₙ.

Here, R₅s are each independently hydrogen; deuterium; halogen; an amine group; an epoxy group; a cyclohexyl epoxy group; a (meth)acryl group; a thiol group; an isocyanate group; a nitrile group; a nitro group; a phenyl group; a C₁-C₄₀ alkyl group unsubstituted or substituted with deuterium, halogen, an amine group, an epoxy group, a (meth)acryl group, a thiol group, an isocyanate group, a nitrile group, a nitro group, or a phenyl group; a C₂-C₄₀ alkenyl group; a C₁-C40 alkoxy group; a C₃-C₄₀ cycloalkyl group; a C₃-C₄₀ heterocycloalkyl group; a C₆-C₄₀ aryl group; a C₃-C₄₀ heteroaryl group; a C₃-C₄₀ aralkyl group; a C₃-C₄₀ aryloxy group; or a C₃-C₄₀ arylthiol group, and n is 6, 8, 10, or 12.

Preferably, at least one of R₅s that are each independently contained in the organosilicon compound is a (meth)acryl group or a C₁-C₄₀ alkyl group substituted with a (meth) acryl group; a C₂-C₄₀ alkenyl group; a C₁-C₄₀ alkoxy group; a C₃-C₄₀ cycloalkyl group; a C₃-C₄₀ heterocycloalkyl group; a C₆-C₄₀ aryl group; a C₃-C₄₀ heteroaryl group; a C₃-C₄₀ aralkyl group; a C₃-C₄₀ aryloxy group; or a C₃-C₄₀ arylthiol group.

The organosilicon compound having a cubic structure [R₅SiO_{3/2}]ₙ includes a polymer structure in the form of a cage including a tetrahedron having Si—O—Si bonds and Si as vertices, is a compound configured such that various substituents R are linked to Si, with an inorganic silicate core and an organic exterior, thus exhibiting superior strength and thermal stability.

The acrylic photocurable resin including the organosilicon compound having a cubic structure [R₅SiO_{3/2}]ₙ may be a resin containing an acrylate and an organosilicon compound introduced with a monofunctional or multifunctional acrylic monomer or containing a functional group having curing reactivity (e.g. an acryl group).

Alternatively, a resin in which the organosilicon compound is dispersed in an acrylate polymer matrix to thus form a crosslinked structure may be exemplified.

The acrylate includes at least one selected from the group consisting of bisphenol-A-type epoxy acrylate, modified-type epoxy acrylate, difunctional acrylate and aliphatic urethane acrylate.

More specifically, the acrylate includes at least one selected from the group consisting of dicyclopentanyl diacrylate (DCPA), dipentaerythritol hexaacrylate (DPHA), difunctional acrylate and aliphatic urethane acrylate.

The acrylic photocurable resin may contain 75 to 85 wt % of the organosilicon compound and 15 to 25 wt % of the acrylate.

When the hard coating layer 20 is formed of the acrylic photocurable resin including the organosilicon compound, the thickness of the hard coating layer 20 may be 5 to 50 μm. If the thickness thereof is less than 5 μm, sufficient hardness required of the present invention cannot be attained. On the other hand, if the thickness thereof exceeds 50 μm, curling may severely occur due to shrinkage upon UV curing. Preferably, the thickness thereof falls in the range of 10 to 30 μm.

When the highly functional AF hard coating film 100 is required to have strength corresponding to a high hardness equivalent to a pencil hardness of 6 H or more, the hard coating layer 20 is formed of an acrylic photocurable resin including nano silica.

The nano silica has a particle diameter of 5 to 50 nm, and preferably 10 to 30 nm. The acrylic photocurable resin including the nano silica may be an acrylate compound including the nano silica, in which the acrylate is the same as the above acrylate.

Using nano silica surface-modified with a silane coupling agent, dispersion in an organic solvent and dispersion stability may be ensured, and compatibility with an acrylic resin may be obtained. The nano silica is surface-treated with a substituted silane compound containing a (meth)acryl group, and thus nano silica containing a (meth)acryl group may be used.

When the highly functional AF hard coating film 100 is required to have strength corresponding to a high hardness equivalent to a pencil hardness of 6 H and anti-glare performance, the hard coating layer 20 is formed of an acrylic photocurable resin including at least one of silica particles and bead particles.

The bead particles include at least one of silicon beads and acrylic beads. The acrylic photocurable resin including silica particles or bead particles may be an acrylate compound including the above particles, in which the acrylate is the same as the above acrylate.

In an embodiment of the present invention, the AF coating layer 30 is formed on the hard coating layer 20 to thus exhibit anti-fouling and anti-fingerprinting performance, and is formed of a perfluoro compound containing an alkoxysilane group.

For the AF coating layer 30 according to the present invention, the perfluoro compound has a large molecular weight and high fluorine concentration and thus may impart effects, such as heat resistance, low surface tension, chemical inactivity, anti-fouling, anti-fingerprinting, and slipping, and contains an alkoxysilane group, and thus may have high bondability with the hard coating layer 20 formed of the compound including a structure having high reactivity with the alkoxysilane group. Thereby, peeling problems occurring upon stacking of an anti-fouling coating layer of an existing plastic film may be solved, which may be based on the results of evaluation of scratch resistance and wear resistance, as will be described later.

More specifically, the AF coating layer 30 is formed of, as the perfluoro compound containing an alkoxysilane group, a compound represented by Chemical Formula 1 below.

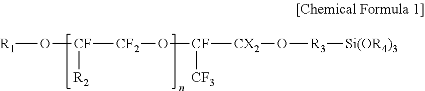

Also, the thickness of the AF coating layer 30 may be 5 to 50 nm. If the thickness thereof is less than 5 nm (0.005 μm), AF properties cannot be sufficiently exhibited. On the other hand, if the thickness thereof exceeds 50 nm (0.050 μm), AF properties are good, but economic benefits are negated due to the use of a large amount of the expensive AF compound, and moreover, inner curing of the film becomes insufficient owing to the thick

AF coating, undesirably deteriorating wear properties.

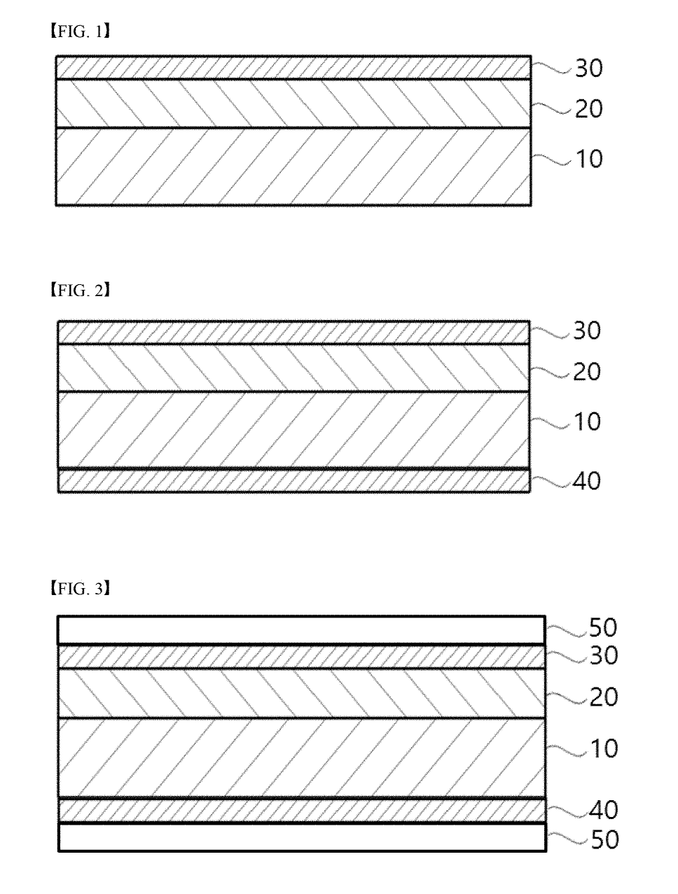

In an embodiment of the present invention, the highly functional AF hard coating film 100 further includes a silicone adhesive layer 40, the silicone adhesive layer 40 being formed on one side of the transparent substrate layer 10. FIG. 2 shows the construction of a highly functional AF hard coating film according to an embodiment of the present invention.

In an embodiment of the present invention, the silicone adhesive layer 40 is an adhesive layer that enables adhesion to a display, and is formed of a silicone adhesive having high thermal stability. The silicone adhesive layer 40 may have a thickness of 10 to 100 μm.

In an embodiment of the present invention, the highly functional AF hard coating film 100 further includes a protective film layer 50 formed on one side or both sides of the highly functional AF hard coating film 100. FIG. 3 shows the construction of a highly functional AF hard coating film according to an embodiment of the present invention.

In an embodiment of the present invention, the protective film layer 50 functions to protect the highly functional AF hard coating film 100 from the external environment, and is formed to a thickness of 20 to 100 μm on one side or both sides of the highly functional AF hard coating film 100.

According to embodiments of the present invention, the highly functional AF hard coating film includes the hard coating layer, the composition and thickness of which vary, and may thus be suitably applied so as to realize requirements such as high film hardness or anti-glare performance.

Also, a film having superior scratch resistance, wear resistance, anti-fouling and anti-fingerprinting while significantly reducing peeling of the AF coating layer formed on the hard coating layer by virtue of the composition for the hard coating layer and the composition for the AF coating layer may be provided.

The film of the invention is applicable to displays such as those of mobile devices, touch panels, car navigation systems and the like, and may thus be used to replace a cover window or to protect tempered glass of a cover window.

### EXAMPLES

### Example 1

On a transparent substrate layer formed of PMMA and having a thickness of 125 μm, an acrylic photocurable resin including an organosilicon compound represented by Chemical Formula 2 below was applied and then cured with UV light to thus form a hard coating layer having a thickness of 20 μm, after which the compound represented by Chemical Formula 1 was applied through spray coating on the hard coating layer to thus form an AF coating layer having a thickness of 0.01 μm, thereby manufacturing a highly functional AF hard coating film.

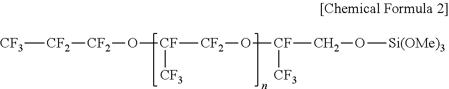

### Example 2

On a transparent substrate layer formed of PET and having a thickness of 188 μm, an acrylic photocurable resin including nano silica surface-modified with a silane coupling agent represented by Chemical Formula 3 below was applied and then cured with UV light to thus form a hard coating layer having a thickness of 20 μm, after which the compound represented by Chemical Formula 1 was applied through spray coating on the hard coating layer to thus form an AF coating layer having a thickness of 10 nm, thereby manufacturing a highly functional AF hard coating film.

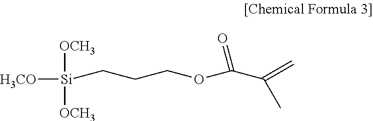 [SMILES: C=C(C)C(=O)OCCC[Si](OC)(OC)OC]

### Example 3

On a transparent substrate layer formed of PC and having a thickness of 250 μm, an acrylic photocurable resin including silica particles and silicon bead particles was applied and then cured with UV light to thus form a hard coating layer having a thickness of 20 μm, after which the compound represented by Chemical Formula 1 was applied through spray coating on the hard coating layer to thus form an AF coating layer having a thickness of 10 nm, thereby manufacturing a highly functional AF hard coating film.

### Comparative Example

On a transparent substrate layer formed of PET and having a thickness of 188 μm, an acrylic UV-curable resin was applied and then cured with UV light to thus form a hard coating layer having a thickness of 20 μm, thereby manufacturing a hard coating film.

### Test Example

1) Measurement of Transmittance and Haze

The highly functional AF hard coating films manufactured in Examples and the hard coating film manufactured in Comparative Example were measured for total transmittance using a spectrophotometer and for haze using a haze meter. The results of measurement of transmittance and haze are shown in Table 1 below.

2) Measurement of Hardness

The highly functional AF hard coating films manufactured in Examples and the hard coating film manufactured in Comparative Example were measured for pencil hardness under a load of 750 g in accordance with a standard PET testing method (pencil hardness measurement method) using a pencil hardness tester. The results of measurement of pencil hardness are shown in Table 1 below.

3) Measurement of Scratch Resistance and Wear Resistance

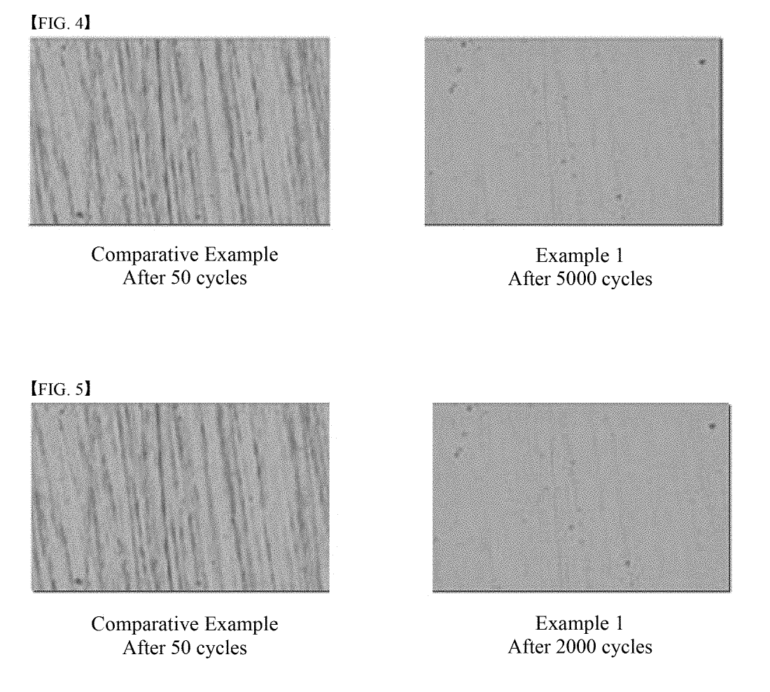

The highly functional AF hard coating films manufactured in Examples and the hard coating film manufactured in Comparative Example were evaluated for scratch resistance by counting the number of cycles at which surface scratching occurred upon reciprocal movement of steel wool (0000#) under a load of 500 gf/cm², and for wear resistance by counting the number of cycles at which a contact angle of 100° or less was obtained. The results of measurement of scratch resistance and wear resistance are shown in Table 1 below, and the surface images thereof are shown in FIGS. 4 and 5.

4) Measurement of Anti-Fouling (Measurement of Water Contact Angle)

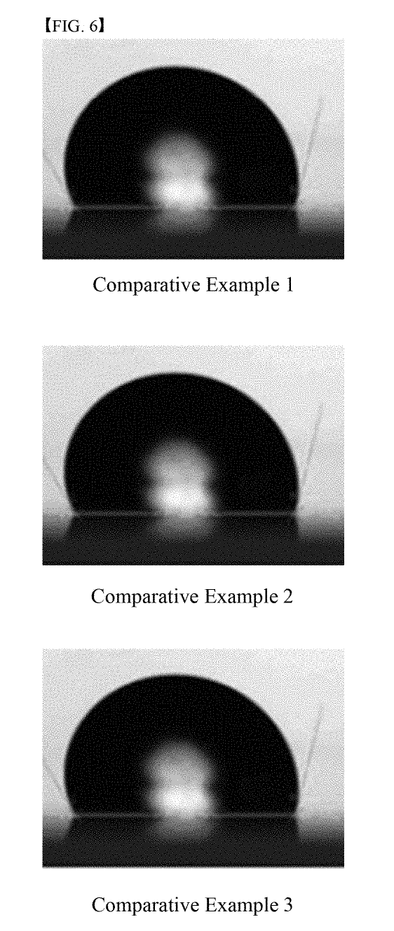

The highly functional AF hard coating films manufactured in Examples and the hard coating film manufactured in Comparative Example were measured for water contact angle using a contact angle meter (KRUSS GmbH Germany, FM40, Easydrop). The results of measurement of water contact angle are shown in Table 1 below, and the images after measurement of water contact angle are shown in FIG. 6.

5) Measurement of Slipping

The highly functional AF hard coating films manufactured in Examples and the hard coating film manufactured in Comparative Example were measured for the coefficient of static friction (μ) in accordance with ASTM-1894 using a friction coefficient meter (TO-170M, made by TESTONE). The results of measurement of slipping are shown in Table 1 below.

TABLE 1

| | | | | Comparative |
|---|---|---|---|---|
| | Example 1 | Example 2 | Example 3 | Example |
| | (PMMA) | (PET) | (AG/PET) | (PET) |
| Transmittance | 91.5 or more | 91.5 or more | 91 or more | 91.5 |
| (%) | | | | |
| Haze (%) | 0.3 | 0.3 | 10 | 0.3 |
| Pencil hardness | 8 H | 6 H | 6 H | 2 H |
| Scratch | 5000 cycles | 4000 cycles | 2000 cycles | 50 cycles |
| resistance | | | | |
| Contact angle | 115 | 114 | 112 | 60 |
| (°) | | | | |
| AF wear | 5000 cycles | 4000 cycles | 2000 cycles | 0 |
| resistance | | | | |
| Slipping (μ) | 0.1 | 0.08 | 0.2 | 0.5 |

As is apparent from the results of Table 1, the

AF hard coating film of Example 1 had ultrahigh hardness equivalent to a pencil hardness of 8 H or more, a water contact angle of 115° , which falls within the range of 100° or more, and a coefficient of static friction of 0.1, and thus exhibited superior anti-fouling and anti-fingerprinting. As shown in FIG. 4, even upon reciprocal movement of 5000 cycles or more, surface scratching did not occur, thus indicating superior mechanical properties such as scratch resistance, etc., and optical properties, including haze of 0.3% and light transmittance of 91.5% or more.

The AF hard coating film of Example 2 had high hardness equivalent to a pencil hardness of 6 H, a water contact angle of 114° , falling within the range of 100° or more, and a coefficient of static friction of 0.08, and thus exhibited superior anti-fouling and anti-fingerprinting. As shown in FIG. 5, even upon reciprocal movement of 4000 cycles or more, surface scratching did not occur, thus indicating superior mechanical properties such as scratch resistance, etc., and optical properties, including haze of 0.3% and light transmittance of 91.5% or more.

The AF hard coating film of Example 3 had high hardness equivalent to a pencil hardness of 6 H, a water contact angle of 112° , falling within the range of 100° or more, and a coefficient of static friction of 0.2, and thus exhibited superior anti-fouling and anti-fingerprinting, and moreover, optical properties, including haze of 10% and light transmittance of 91% or more, resulting in anti-glare effects.

The features, structures, effects and so on illustrated in individual exemplary embodiments as above may be combined or modified with other exemplary embodiments by those skilled in the art. Therefore, content related to such combinations or modifications should be understood to fall within the scope of the present invention.

### DESCRIPTION OF THE REFERENCE NUMERALS IN THE DRAWINGS

100: highly functional AF hard coating film

10: transparent substrate layer

20: hard coating layer

30: AF coating layer

40: silicone adhesive layer

50: protective film layer

1. A highly functional AF hard coating film, comprising:
a transparent substrate layer functioning as a film substrate;
a hard coating layer formed on the transparent substrate layer and functioning to exhibit high strength or anti-glare performance; and
an AF coating layer formed on the hard coating layer and functioning to exhibit high adhesion to the hard coating layer and anti-fouling performance.

2. The highly functional AF hard coating film of claim 1, wherein the hard coating layer is formed of a compound including a structure having reactivity with an alkoxysilane group, and the AF coating layer is formed of a perfluoro compound containing an alkoxysilane group.

3. The highly functional AF hard coating film of claim 2, wherein the AF coating layer is a coating layer formed of a compound represented by Chemical Formula 1 below.

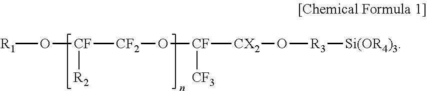

4. The highly functional AF hard coating film of claim 3, wherein the hard coating layer is a high-strength coating layer formed of an acrylic photocurable resin including an organosilicon compound having a cubic structure [R₅SiO3/2]ₙ, with a thickness of 5 to 50 μm (R₅s are each independently hydrogen; deuterium; halogen; an amine group; an epoxy group; a cyclohexyl epoxy group; a (meth)acryl group; a thiol group; an isocyanate group; a nitrile group; a nitro group; a phenyl group; a C₁-C₄₀ alkyl group unsubstituted or substituted with deuterium, halogen, an amine group, an epoxy group, a (meth)acryl group, a thiol group, an isocyanate group, a nitrile group, a nitro group, or a phenyl group; a C₂-C₄₀ alkenyl group; a C₁-C₄₀ alkoxy group; a C₃-C₄₀ cycloalkyl group; a C₃-C₄₀ heterocycloalkyl group; a C₆-C₄₀ aryl group; a C₃-C₄₀ heteroaryl group; a C₃-C₄₀ aralkyl group; a C₃-C₄₀ aryloxy group; or a C₃-C₄₀ arylthiol group, and n is 6, 8, 10, or 12).

5. The highly functional AF hard coating film of claim 4, wherein at least one of R₅s that are each independently contained in the organosilicon compound is a (meth)acryl group or a C₁-C₄₀ alkyl group substituted with a (meth)acryl group; a C₂-C₄₀ alkenyl group; a C₁-C₄₀ alkoxy group; a C₃-C₄₀ cycloalkyl group; a C₃-C₄₀ heterocycloalkyl group; a C₆-C₄₀ aryl group; a C₃-C₄₀ heteroaryl group; a C₃-C₄₀ aralkyl group; a C₃-C₄₀ aryloxy group; or a C₃-C₄₀ arylthiol group.

6. The highly functional AF hard coating film of claim 5, wherein the acrylic photocurable resin includes an acrylate and an organic compound introduced with a monofunctional or multifunctional acrylic monomer, the acrylate including at least one selected from the group consisting of dicyclolpentanyl diacrylate (DCPA), dipentaerythritol hexaacrylate (DPHA), difunctional acrylate and aliphatic urethane acrylate.

7. The highly functional AF hard coating film of claim 3, wherein the hard coating layer is a high-strength coating layer formed of an acrylic photocurable resin including nano silica surface-modified with a silane coupling agent, with a thickness of 5 to 50 μm.

8. The highly functional AF hard coating film of claim 3, wherein the hard coating layer is an anti-glare coating layer formed of an acrylic photocurable resin including at least one of silica particles and bead particles, with a thickness of 5 to 50 μm, the bead particles including at least one of silicon beads and acrylic beads.

9. The highly functional AF hard coating film of claim 4, wherein the highly functional AF hard coating film has a pencil hardness of 6 H or more under a load of 750 g, a transmittance of 91.5% or more, and a water contact angle of 100° or more.

10. The highly functional AF hard coating film of claim 1, wherein the transparent substrate layer has a thickness of 20 to 3000 μm, and the AF coating layer has a thickness of 5 to 50 nm.
